(19) United States
(12) Patent Application Publication
(10) Pub. No.: US 2004/0125950 A1
(43) Pub. Date: Jul. 1, 2004

(54) Method for protecting public key schemes from timing, power and fault attacks

(76) Inventors: Sung-Ming Yen, Tao-Yuan (TW); Chih-Chung Lu, Taipei (TW); Shau-Yin Tseng, Hsin-Chu (TW)

Correspondence Address: LAW OFFICES OF CLEMENT CHENG, 17220 NEWHOPE STREET #127, FOUNTAIN VALLEY, CA, 92708, US

(21) Appl. No.: 10/615,065

(22) Filed: Jul. 8, 2003

(30) Foreign Application Priority Data
Dec. 27, 2002 (TW) 091137721

(51) Int. Cl. H04K 1/00

(52) U.S. Cl. 380/30

(57) ABSTRACT

The present invention provides a method for protecting public key schemes from timing, power and fault attacks. In general, this is accomplished by implementing critical operations using “branchless” or fixed execution path routines whereby the execution path does not vary in any manner that can reveal new information about the secret key during subsequent operations. More particularly, the present invention provides a modular exponentiation algorithm without any redundant computation so that it can protect the secret key from C safe error attacks. The improved method also provides an algorithm that doesn't have a store operation with non-certain destination so that the secret key is immune from M safe error attacks.

### BACKGROUND OF THE INVENTION

1. Field of the Invention

The present invention generally relates to make a number-theoretic public key scheme and more particularly, a scheme for protecting public key from timing, power monitoring and fault attacks.

2. Description of the Prior Art

In conventional cryptosystems, crypotographic algorithm is derived from mathematical models. It makes people believe it is impossible to extract secret key with a low complexity algorithm. However some problems caused during crypotographic implementations are not considered within mathematical models and what allows attacks to find out the secret keys via some indirect techniques such like microprobing, reverse engineering, memory read-out techniques, etc. To prevent these attacks, a variety of physical techniques for protecting cryptographic devices are known, including enclosing key management systems in physically durable enclosures, coating integrated circuits with special coatings that destroy the chip when removed, and wrapping devices with fine wires that detect tampering. However, these approaches are difficult to use in single-chip solutions (such as smartcards), and difficult to evaluate since there is no mathematical basis for their security. Physical tamper resistance techniques are also ineffective against some attacks.

In the past five years, it has shown that attackers can non-invasively extract secret keys using careful measurement and analysis of many devices' power consumption. Analysis of timing measurements or electromagnetic radiation can also be used to find secret keys.

Many public-key encryption algorithms, like the RSA encryption and decryption system or the Diffie-Hellman key exchange system, are based on the mathematical operation of modulo exponentiation. This operation can be described as follows:

C=M^{e} mod n.

In other words, to compute C, raise M to the power of e and divide it by n, then save the remainder of the division instead of the quotient. In a typical RSA calculation, M would be the clear text message to be signed, e would be the private key, n would be the public key (the modulus), and C would be the ciphertext.

Modulo calculations, or synonymously, modular calculations, can be performed by electronic equipment. As the exponent, e, and the ciphertext, M, and size of n increases, the modulo calculations become time and power consuming to the electronic circuits. Generally, computation time depends on the size of n and the value of e. In hardware, circuits that implement modulo mathematics, n and e also provide an indication of the amount of power consumed by the circuit while performing the operation.

As mentioned above, n is publicly known as a public key, but e could be a private key that should be kept secret in order to maintain the integrity of the encryption system. In order to calculate C, it is useful to break the modulo exponentiation up into a multiple of simple operations. Usually, the modulo exponentiation is split up into a series of modulo-square and modulo-multiplication operations. “Modulo” in this context means division by the modulus while saving the remainder of the operation.

According to “Paul C. Kocher in his paper, Timing attacks on implementations of Diffie-Hellman, RSA, DSS, and other systems, Proceedings of Crypto '96, 1996”, and “Paul C. Kocher in his paper, Kocher, Cryptanalysis of Diffie-Hellman, RSA, DSS, and other systems using timing attacks, Dec. 7, 1995”, some information about the crypotographic key leak out by measuring the length of cryptographic computation.

When modulo mathematics is performed, the computation is generally performed using binary numbers, from most significant (MSB) to least significant (LSB), i.e., from left to right, and performing the modulo computation described in FIG. 1. As shown in FIG. 1, notice that each time a 1 is encountered then a modulo-square (line 3) is performed with the intermediate result, which is initialized to a 1 , and then a modulo-multiply with M is performed (line 5). When a 0 is encountered only a modulo-square is performed (line 3) on the intermediate result to get the next intermediate result. Thus, depending on whether the condition of line 4 was satisfied (a 1 or a 0 was present in a position in the private key, e exponent), it may take different amounts of time to calculate the next intermediate result. Thus, the attacker may first observe a set of operations while measuring the time (t) taken to compute each C=M^{e} mod n and find out what the secret key is.

Another attack available to an attacker is to monitor the power consumption of the integrated circuit. Generally, the modulo math calculation of a modulo-multiply and a modulo-square will each require a different amount of energy when implemented in either hardware or firmware in an integrated circuit. When implement a modulo-multiply, it will have power peak wider than implement a modulo-square. An attacker could monitor the power consumption of an integrated circuit to determine the exponent e.

When 1 is encountered (a modulo-square is performed with the intermediate result, and then a modulo-multiply with M is performed), it will show a narrow power peak followed by a wide power peak in the power consumption trace. When 0 is encountered (only a modulo-square is performed on the intermediate result to get the next intermediate result), it will only show a narrow power peak in the power consumption trace. According to power consumption of FIG. 2, we can find out that the secret key is 00111.

As the aforementioned, operation of modulo-multiplication or modulo-squaring occurs at any particular time is controlled by a conditional jump (line 4 in FIG. 1) that depends on the value of the exponent, e, as it is traversed, commonly bit-by-bit. Based on this simple theory, there is an improved crypotographic algorithm which is shown in FIG. 3. This algorithm reduces leakage from cryptosystems by implementing critical operations using fixed execution path routines whereby the execution path does not vary in any manner that can reveal useful information about the secret key during subsequent operations so as to protect crypotographic keys against timing attacks and power monitoring attacks.

Due to the advanced attack techniques, there are more and more new approaches to attack cryptosystem, some techniques used to prevent attacks in the past were not strong enough to provide protection against new attacks anymore. According to “Sung-Ming Yen, Seung-Joo Kim, Seon-Gan Lim, and Sang-Jae Moon. A Countermeasure against One Physical Cryptanalysis May Benefit Another Attack. Information Security and Cryptology-ICISC 2001, volume 2288 of Lecture Notes in Computer Science, pages 414-427. Springer-Verlag, 2002”, there is a fault attack technique called “C safe error”. And there's still another fault attack called “M safe error” which is proposed by “Sung-Ming Yen and Marc Joye. Checking Before Output May Not Be Enough against Fault-Based Cryptanalysis. IEEE Trans. On Computers, 49(9): 967-970, September 2000”. It will be shown that the cryptographic algorithms in FIG. 3 can not immune from C safe error attacks or M safe error attacks.

Fault attacks try to introduce errors into the crypotographic computation, and to identify the key by analyzing the mathematical and statistical properties of the erroneously computed results. Among the many techniques that suggested so far for introducing such errors are the uses of ionizing radiation, unusual operating temperatures, power and clock glitches, and laser-based chip microsurgery.

C safe-error attacks introduce temporal error within ALU so as to induce temporal erroneous computation. Some of the attacks carry out an erroneous computation, while others won't. Upon these different outputs, some information of the crypotographic key will be revealed. In FIG. 3, when some eₖ=0, S_{b}=(S_{b}·S₂) mod n is a redundant computation. It is to say that if a temporal error is introduced during this computation, it will induce an erroneous computation but this erroneous result will not affect the next computation cycle, so the final output will still be the same. If the attacker introduce a single error at a random time during the computation of S_{b}=(S_{b}·S₂) mod n, by observing whether the output of the computation is with error or not, the attacker can realize the corresponding bit of the secret key. If the output is with error, the corresponding digit of the secret key is 1; otherwise, the corresponding digit of the secret key is 0.

As for the M safe-error attack, suppose we have an operation Y=(X·Y) mod n which means after the computation of X·Y mod n, the result is reassigned to register Y. In the modular computation, both X and Y are with very long digits (for example 1024 bits), and regular CPU only can do multiplication with 32 bits, so multiplicator will be separated into 32 blocks with 32 bits in each block. Therefore the multiplication of X and Y will be computed separately such as Y₀=(X·Y₀) mod n, Y₁=(X·Y₁) mod n, . . . , Y₃₁=(X·Y₃₁) mod n. Therefore, if one or several bits of error are introduced into the more significant bit positions of register, no error will be detected after restoring the result into Y if the faulty bits belonging to the block Yᵢ are no longer required. If we change the operation into Y=(Y·X) mod n, as aforementioned, if an error is introduced in block Xⱼ, then register X is not cleared and the final value will be incorrect. With the temporary error, the attacker can realize the corresponding bit of the secret key. If the output is with error, the corresponding bit of the secret key is 0; otherwise, the corresponding bit of the secret key is 1.

The algorithm provided by FIG. 3, if eₖ=1, it needs to calculate S₀=(S₂·S₀) mod n. If an attacker uses C safe-error attack and a temporary error is introduced during this computation, it will cause an erroneous result in Sₒ. And this erroneous result So will affect the next computation cycle, so the final output will be incorrect. If the attacker introduces a single error at a random time during the computation of S_{b}=(S₂·S_{b}) mod n, by observing whether the output of the computation is with error or not, the attacker can realize the corresponding bit of the secret key. If the output is with error, the corresponding bit of the secret key is 1; otherwise, the corresponding bit of the secret key is 0.

In accordance with the above description, a new and improved cryptographic algorithm which can protect secret keys from timing attacks, power attacks, C safe-error attacks and M safe-error attacks is therefore necessary.

### SUMMARY OF THE INVENTION

In accordance with the present invention, a novel crypotographic algorithm is provided that substantially overcomes the drawbacks of the above mentioned problems.

Accordingly, it is one object of the present invention to provide protective techniques without conditional jump in the modular exponentiation algorithm for public key schemes, which provide strong protection against the described timing and power monitoring attacks.

It is another object for present invention to provide a modular exponentiation algorithm without any redundant calculation in it so as to be substantially immune from both C safe-error attack.

It is still another object for present invention to provide a modular exponentiation algorithm for public key schemes without any store operation having non-certain destination so as to prevent the M safe-error attack intended to determine a private key.

In according to the foregoing objectives, the present invention provides a method for protecting public key schemes from timing, power and fault attacks. In general, this is accomplished by implementing critical operations using “branchless” or fixed execution path routines whereby the execution path does not vary in any manner that can reveal new information about the secret key during subsequent operations. More particularly, the present invention provides a modular exponentiation algorithm without any redundant computation so that it can protect the secret key from C safe-error attacks. The improved method also provides an algorithm that doesn't have a store operation with non-certain destination so that the secret key is immune from M safe error attacks. Furthermore, in the modulo exponentiation algorithm, the times of the multiplication doesn't change resulting from different exponentiations for protecting from timing attack.

This invention provides a method, an apparatus or a computer-readable medium for protecting public key schemes from timing, power monitoring and fault attacks comprising the steps of: 1. obtaining a message for use in a crypotographic operation; 2. obtaining a modulus and an exponent corresponding to said crypotographic operation, wherein said exponent contains at least one bit; 3. initializing a first value as a one, and assigning the message to a second value; 4. executing a modulo exponentiation algorithm on each bit of the exponent from a most significant bit to a least significant bit, wherein the algorithm comprising the steps of: a. input a bit to an inverter and storing the output as a third value, and assigning the next bit of the exponent as a fourth value; b. if the third value is a zero, updating the first value with the result of squaring, modulo the modulus the first value, if the third value is a one, updating the first value with the result of multiplying, modulo the modulus said first value by the second value; and c. if the fourth value is a zero, updating the first value with the result of squaring, modulo the modulus the first value, if the fourth value is a one, updating the first value with the result of multiplying, modulo the modulus the first value by the second value; 5. updating the bit with the next bit of the exponent, and executing steps of the algorithm on the bit until the bit being the least significant bit of the exponent; and 6. storing and output the first value.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows the modular exponentiation algorithm of C=M^{e} mod n;

FIG. 2 shows the power consumption diagram of algorithm from FIG. 1;

FIG. 3 shows the modular exponentiation algorithm of C=M^{e} mod n which is immune from both timing attacks and power monitoring attacks;

FIG. 4 shows the algorithm which is immune from fault attacks;

FIG. 5 shows the flow chart of the algorithm from FIG. 4; and

FIG. 6 shows the comparison table of the algorithm from FIG. 1 and FIG. 4 when exponent is 10001100.

### DESCRIPTION OF THE PREFERRED EMBODIMENT

Referring now to the drawings, preferred embodiments will now be 20 described in detail. Since public key schemes and computer hardware and software implementation are well known to those of skill in the art, no description of same is deemed necessary to a full, concise, and exact understanding of the present invention.

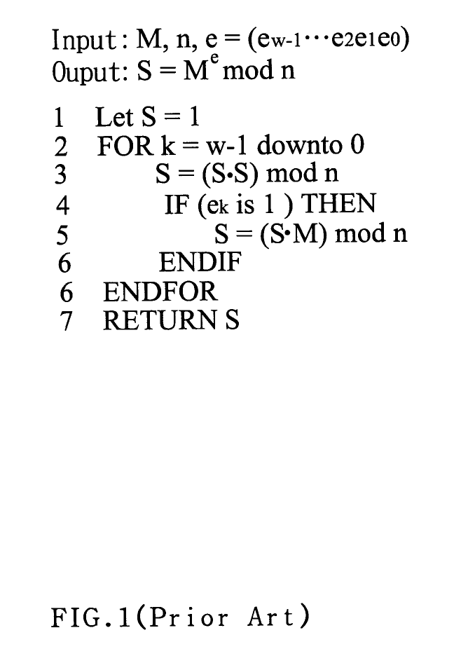

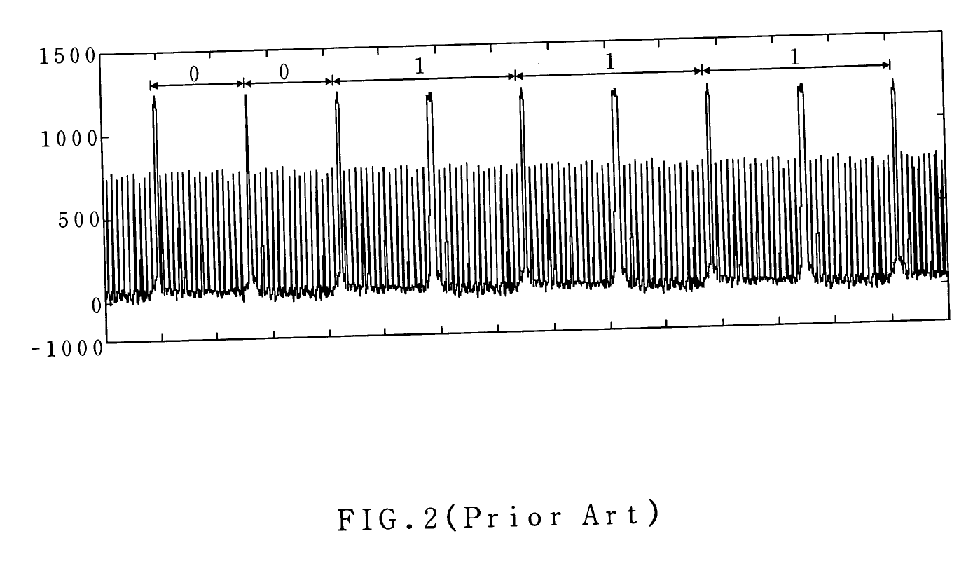

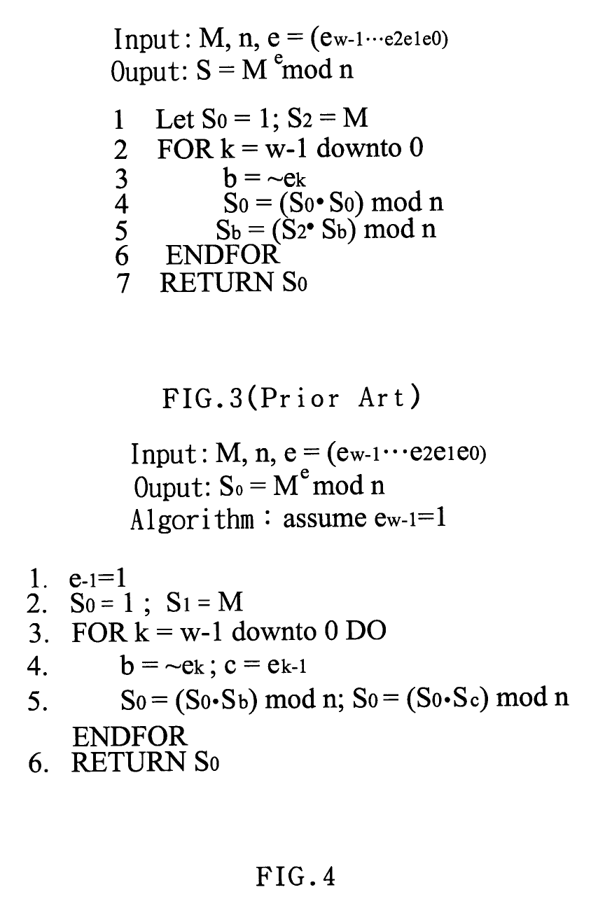

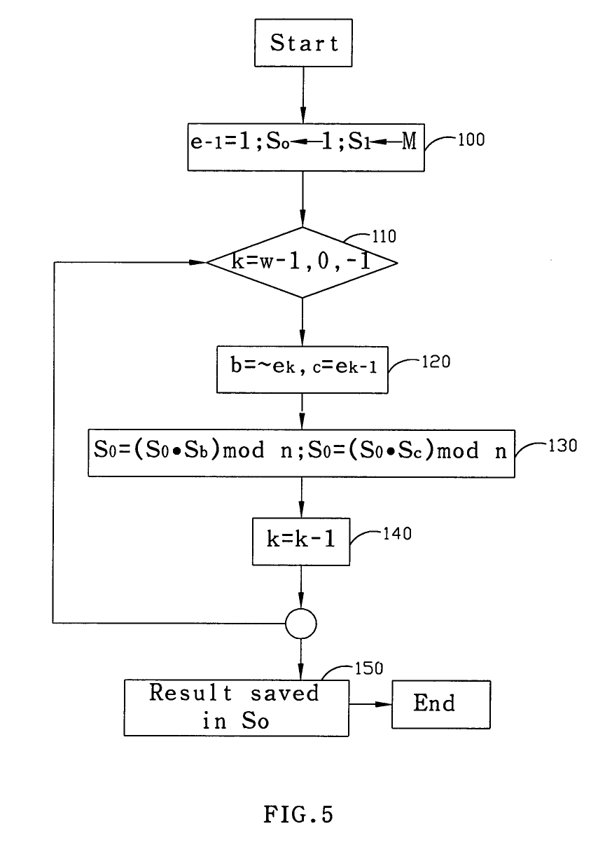

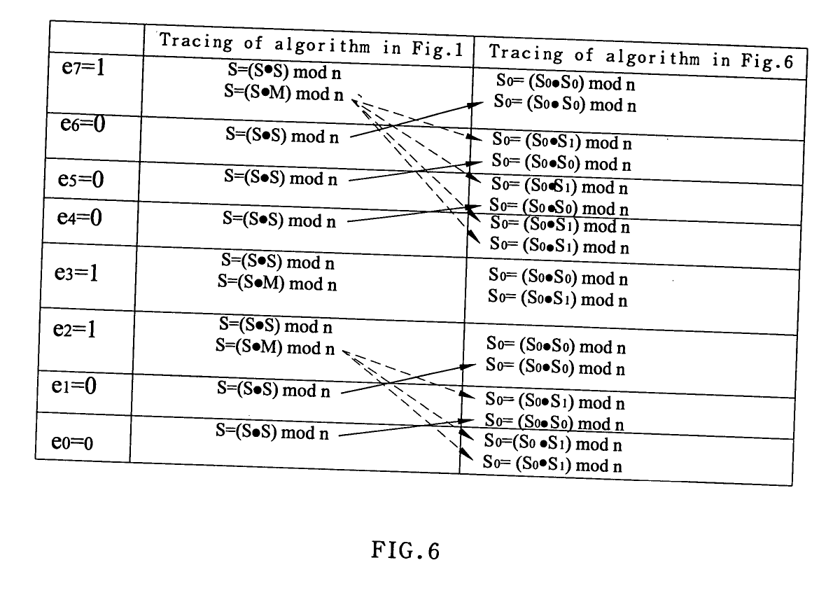

Those skilled in the art will recognize that the algorithm in FIG. 1 describes one commonly used conventional procedure for computing R=Mêmod n, where “\hat{ }” denotes exponentiation. As will be inherently understood to those skilled in the art, the base M is the message, e is exponent, and n is modulus. As aforementioned, the procedure in FIG. 1, security is compromised if an attacker can determine whether or not the device actually performed the modular multiplication step S=(S·M) mod n because this determines whether the k-th bit of the exponent e is one or zero. By monitoring the occurrence of modular multiplication as exponentiation occurs on a bit-by-bit basis, the exponent can therefore be determined.

The novel protective technique for public key schemes which provide strong protection against the described timing attacks, power monitoring attacks, and more particularly against C safe-error attacks and M safe-error attacks will now be described. Moreover, not only the RSA public key schemes, but also any system on the basis of discrete logarithm can be employed with the algorithm of the present invention.

The present invention provides an algorithm as in FIG. 4. At the beginning, obtaining a message M for use in a crypotographic operation and an exponent e=(e_{w-1}, e_{w-2}, . . . , e₁, e₀) and a correlated modulus n then initializing S₀=1, assigning M to S1, and let e₋₁₌1 (100), then set k=w−1 and executing a modulo exponentiation algorithm on each bit of the exponent from the most significant bit (e_{w-1}) to the least significant bit (e₀), wherein the algorithm comprising the steps of: 1. Input the bit eₖ to an inverter and storing the output as a value b, and assigning the next bit eₖ₋₁ as a value c; 2. Executing S₀=(S₀·S_{b}) mod n and S₀=(S₀·S_{c}) mod n (130) 3. Executing k=K−1 (140); 4. Repeating step 1 to step 3 until finishing the loop of k=0; 5. Storing and output S₀ (150).

Next, we will illustrate the correctness of the present invention. FIG. 6 shows the comparison of two algorithms provided by FIG. 1 and FIG. 4 when the exponent with standard binary representation “10001100”. In order to execute two calculations in each iteration, as shown in FIG. 6, the algorithm in FIG. 4 calculates the S=(S·S) mod n, which belongs to the second digit eₖ=0, one iteration ahead. Due to the pre-calculation of the S=(S·S) mod n, the remaining calculation S=(S·M) mod n will be postponed to the next iteration. If the procedure of 1. S=(S·M) mod n; 2. S=(S·S) mod n is changed to calculate S=(S·S) mod n first, based on the mathematical derivation, the following S=(S·M) mod n should be calculated twice in order to get the same result. Therefore, if we pre-calculate S=(S·S) mod n, then the previous procedure should become 1. S=(S·S) mod n; 2. S=(S·M) mod n; 3. S=(S·M) mod n.

In the beginning, during the seventh iteration e₇=1, the calculations of “S=(S₀·S₀) mod n” and “S=(S₀·S_{c}) mod n” where c=e₆ will be executed. Therefore, during the seventh iteration, the calculations should be “S=(S₀·S₀) mod n” and “S=(S₀·S₀) mod n” in turn within which the first calculation of “S=(S₀·S₀) mod n” is an original procedure but the second calculation of “S=(S₀·S₀) mod n” is pre-calculated due to e₆=0.

The next iteration is the sixth iteration where e₆=0, and the calculations of “S=(S₀·S₁) mod n” and “S=(S₀·S_{c}) mod n” where c=e₅ will be executed. Therefore during the sixth iteration, the calculations should be “S=(S₀·S₁) mod n” and “S=(S₀·S₀) mod n” in turn within which the first “S=(S₀·S₁) mod n” is an original procedure, but the second calculation of “S=(S₀·S₀) mod n” is pre-calculated due to e₅=0. The calculation of “S=(S₀·S₁) mod n” which should have been done twice in row in this iteration is only executed once, so there is still one “S=(S₀·S₁) mod n” left, and due to the second calculation “S=(S₀·S₀) mod n” is performed first so the remaining one “S=(S₀·S₁) mod n” should be calculated twice in the next row.

The following fifth iteration e₅=0 executes the same procedures as the sixth loop so we will not describe the detail here.

The next iteration is the fourth iteration where e₄=0, and the calculations of “S=(S₀·S₁) mod n” and “S=(S₀·S_{c}) mod n” where c=ₑ₃ will be executed. Therefore, during the fourth iteration, the calculations should be “S=(S₀·S₁) mod n” and “S=(S₀·S₁) mod n” in turn which just make up for the remaining calculations left by the previous iteration.

The next iteration is the third iteration where e₃=1, and the calculations of “S=(S₀·S₀) mod n” and “S=(S₀·S_{c}) mod n” where c=e₂ will be executed. Therefore, during the third iteration, the calculations should be “S=(S₀·S₀) mod n” and “S=(S₀·S₁) mod n” in turn which is the same as the algorithm provided by FIG. 1.

The second iteration where e₂=1 is the same as the seventh iteration, and the first iteration where e₁=0 is the same as the sixth iteration.

As for the final iteration, the iteration zero with e₀=0, the calculations of “S=(S₀·S₁) mod n” and “S=(S₀·S_{c}) mod n” where c=e₋₁ will be executed. In this algorithm, we assume e_{-1 =}1, so the calculations should be “S=(S₀·S₁) mod n” and “S=(S₀·S₁) mod n” which just make up for the remaining calculations left by the previous iteration.

As above mentioned, the present invention provides a method for protecting public key schemes from timing, power and fault attacks. In general, this is accomplished by implementing critical operations using “branchless” or fixed execution path routines whereby the execution path does not vary in any manner that can reveal new information about the secret key during subsequent operations. More particularly, the present invention provides a modular exponentiation algorithm without any redundant computation so that it can protect the secret key from C safe error attacks. The improved method also provides an algorithm that doesn't contain a store operation with non-certain destination so that the secret key is immune from M safe error attacks.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for protecting public key schemes from timing, power monitoring and fault attacks comprising the steps of:
obtaining a message for use in a crypotographic operation;
obtaining a modulus and an exponent corresponding to said crypotographic operation, wherein said exponent contains at least one bit;
initializing a first value as a one, and assigning said message to a second value;
executing a modulo exponentiation algorithm on each bit of said exponent from the most significant bit to the least significant bit, wherein said algorithm comprising the steps of:
input a bit to an inverter and storing the output as a third value, and assigning the next bit of said bit as a fourth bit;
if said third value is a zero, updating said first value with the result of squaring, modulo said modulus said first value, if said third value is a one, updating said first value with the result of multiplying, modulo said modulus said first value by said second value; and
if said fourth value is a zero, updating said first value with the result of squaring, modulo said modulus said first value, if said fourth value is a one, updating said first value with the result of multiplying, modulo said modulus said first value by said second value;
updating said bit with the next bit of said bit, and executing steps of said algorithm on said bit until said bit being said least significant bit of said exponent; and
storing and output said first value.

2. A method according to claim 1, wherein if said bit is said least significant bit of said exponent, said fourth value is initialized as 1.

3. A method according to claim 2, wherein said bit is one bit of bits of said exponent and is a one or a zero.

4. A method according to claim 1, wherein said inverter is used for output a one if input a zero into it, and output a zero if input a one into it.

5. An apparatus for protecting public key schemes from timing, power monitoring and fault attacks comprising:
means for obtaining a message for use in a crypotographic operation;
means for obtaining a modulus and an exponent corresponding to said crypotographic operation, wherein said exponent contains at least one bit;
means for initializing a first value as a one, and assigning said message to a second value;
means for executing a modulo exponentiation algorithm on each bit of said exponent from the most significant bit to the least significant bit, wherein said algorithm comprising:
means for input a bit into an inverter and storing the output as a third value, and assigning the next bit of said bit as a fourth bit;
means for determining whether said third value is a one or a zero;
means for updating said first value with the result of squaring if said third value is a one, modulo said modulus said first value, updating said first value with the result of multiplying, modulo said modulus said first value by said second value if said third value is a one;
means for determining whether said fourth value is a one or a zero; and
means for updating said first value with the result of squaring, modulo said modulus said first value if said fourth value is a zero, updating said first value with the result of multiplying, modulo said modulus said first value by said second value if said fourth value is a one;
means for updating said bit with the next bit of said bit, and executing steps of said algorithm on said bit until said bit being said least significant bit of said exponent;
means for determining whether said bit is a one or a zero; and
means for storing and output said first value.

6. An apparatus according to claim 5, wherein said bit is one bit of bits of said exponent and is a one or a zero.

7. An apparatus according to claim 5, wherein said inverter is used for output a one if input a zero into it, and output a zero if input a one into it.

8. A computer-readable medium for protecting public key schemes from timing, power monitoring and fault attacks containing logic code that executing the steps of:
obtaining a message for use in a crypotographic operation;
obtaining a modulus and an exponent corresponding to said crypotographic operation, wherein said exponent contains at least one bit;
initializing a first value as a one, and assigning said message to a second value;
executing a modulo exponentiation algorithm on each bit of said exponent from the most significant bit to the least significant bit, wherein said algorithm comprising the steps of:
input a bit to an inverter and storing the output as a third value, and assigning the next bit of said bit as a fourth bit;
if said third value is a zero, updating said first value with the result of squaring, modulo said modulus said first value, if said third value is a one, updating said first value with the result of multiplying, modulo said modulus said first value by said second value; and
if said fourth value is a zero, updating said first value with the result of squaring, modulo said modulus said first value, if said fourth value is a one, updating said first value with the result of multiplying, modulo said modulus said first value by said second value;
updating said bit with the next bit of said bit, and executing steps of said algorithm on said bit until said bit being said least significant bit of said exponent; and
storing and output said first value.

9. A computer-readable medium according to claim 8, wherein if said bit is said least significant bit of said exponent, said fourth value is initialized as 1.

10. A computer-readable medium according to claim 9, wherein said inverter is used for output a one if input a zero into it, and output a zero if input a one into it.

11. A computer-readable medium according to claim 8, wherein said bit is one bit of bits of said exponent and is a one or a zero.
